(19) United States
(12) Patent Application Publication
(10) Pub. No.: US 2002/0007814 A1
(43) Pub. Date: Jan. 24, 2002

(54) Internal combustion engine

(76) Inventor: Pierre G. Mansur, Pinecrest, FL (US)

Correspondence Address: Robert M. Downey, ROBERT M. DOWNEY P.A., 150 E. Palmetto Park Road, Suite 350, Boca Raton, FL, 33432, US

(21) Appl. No.: 09/909,478

(22) Filed: Jul. 21, 2001

Related U.S. Application Data
(60) Provisional application No. 60/220,090, filed on Jul. 21, 2000.

(51) Int. Cl. F02B 75/32

(52) U.S. Cl. 123/197.1

(57) ABSTRACT

A compact internal combustion engine includes an engine housing, an arrangement of cylinders, a reciprocating piston in each cylinder, a crankshaft extending through the engine housing, a cam crank fitted to the crankshaft and rotatable therewith, and a valve assembly. A connecting rod of each piston is coupled to the cam crank via a bearing assembly in a manner which causes the coupled end of each piston connecting rod to follow a continuous path of predetermined configuration throughout each piston stroke to thereby transmit the linear power of combustion into a rotating force. The bearing assembly is structured and disposed to maintain the connecting rods in coupled connection with the cam crank when subjected to both downward forces and outward separating forces which occur throughout rotation of the cam crank as the coupled connection follows the continuous path. In a preferred embodiment, the continuous path is defined by one or more cam-shaped grooves formed in the cam crank which serve to direct the reciprocating pistons through four complete strokes with each rotation of the cam crank so that each cylinder delivers one power stroke for each rotation of the crankshaft.

### BACKGROUND OF THE INVENTION

1. Field of the Invention

The present invention relates to internal combustion engines and, more particularly, to a compact, lightweight internal combustion engine having a plurality of pistons and cylinders, wherein the pistons are coupled to a crank on a crankshaft in a manner which maintains the pistons in straight, axial alignment within the cylinders throughout each stroke movement as the coupled attachment follows a precise cam-shaped path both under a positive downward force and during centrifugal acting outward forces while transferring lineal motion into rotating power.

2. Discussion of the Related Art

The four cycle internal combustion engine, commonly referred to as an Otto-cycle engine, named after the inventor Nikolaus A. Otto, is widely known and used in aircraft, automotive, marine and industrial fields. Like other combustion engines, the Otto-cycle engine uses combustion chambers, wherein each combustion chamber consists of a cylinder and a closely fitted piston which slides within the cylinder. The space between the sides of the cylinder and the edges of the piston is sealed with piston rings, and friction is reduced by introducing lubricating oil along the cylinder wall. The piston is attached to a connecting rod, which in turn is coupled to a crankshaft so that the up and down reciprocating motion of the piston can be converted into rotary motion. Typically, four to eight cylinders are used, with each piston connected to the crankshaft. A gasoline and air mixture is introduced into each combustion chamber and compressed upon upward movement of the piston. The fuel air mixture is ignited at the correct moment, usually near top dead center of the piston stroke, with the use of a spark plug. In order to maintain smooth, uninterrupted rotation of the crankshaft, the cylinders must be fired in accordance with an exact timing and sequence.

While the Otto-cycle internal combustion engine is known to be reliable, it is limited by a low power to weight ratio which is inherent in four stroke engines. Additionally, because only a fraction of the energy of the fuel is converted to useful power, the efficiency of the Otto-cycle engine is limited. Generally, only between 18%-20% of the energy in the air/fuel mixture is converted to mechanical power, while the remainder is wasted as heat is released into the cooling system and engine exhaust. Also, a large portion of the mechanical power is further absorbed by internal friction during the remaining three cycles. Further, the complex structure of the conventional four cycle internal combustion engine makes it difficult to reduce engine size and engine weight. Moreover, the engine structure limits the use of certain materials, such as ceramics, which have become popular in engines for improving engine efficiency and power, while reducing friction. Additionally, the coupling of the connecting rods to the conventional crank requires constant pivoting and angled movement of the connecting rods as the crank rotates. This angled movement causes side loading of the piston heads against the cylinder walls, eventually causing engine wear and failure. In order to maintain a seal with the cylinder walls, piston heads in conventional four cycle internal combustion engines require high tension, high friction piston rings. The piston rod and crank arrangement in the convention four cycle combustion engine also limits each piston to one power stroke for every two complete rotations (i.e., 720°) of the crankshaft; a factor which is directly related to the engines available horsepower. To further smooth an engine's performance, cumbersome and costly counterbalance weights are needed in the design of a conventional crankshaft. Also, special consideration must be given to the proper firing order to maintain a balance.

The present invention overcomes many of the limitations associated with the conventional 4-cycle internal combustion engine and provides a lightweight, compact and balanced combustion engine which produces greater horsepower and fuel economy compared to a conventional 4-cycle internal combustion engine having the same number of cylinders. An important feature of the present invention is the ability to efficiently, practically and reliably convert the linear motion of reciprocating pistons into rotating power with the use of a cam crank and bearing assembly for coupling the connecting rods of the engine's pistons to the cam crank.

The use of cam devices to convert either linear motion into rotary motion or rotary motion into linear motion is well known. In the past, others have proposed use of various cam devices for the conversion of reciprocating motion into rotary motion in internal combustion engines. Examples of the use of cam devices in internal combustion engines are found in the U.S. patents to: Rightenour, U.S. Pat. No. 1,728,363; Napper, U.S. Pat. No. 2,528,386; and Williams, U.S. Pat. No. 5,060,603. The distinct differences between the present invention and the various cam devices used to generate power in the related art, including those disclosed in the above patents, lies in the means for attachment of the piston rods to the cam crank which enables the coupled connection to follow a specific profile or path. The present invention employs a positive mechanical means to effectively, practically, reliably and inexpensively guide, control, attach and accurately follow a cam-shaped path both under a positive downward force and during centrifugal acting outward forces within a compact unit while transferring linear motion into rotating power. The unique cam crank and piston rod coupling assembly of the present invention provides for the ease of attaching multiple linear, power-producing units to a single crank.

### OBJECTS OF THE INVENTION

In view of the problems associated with conventional four stroke internal combustion engines, it is a primary object of the present invention to provide a lightweight, compact, balanced combustion engine which produces greater horsepower and fuel economy.

It is a further object of the present invention to provide a positive mechanical means to effectively, practically, reliably and inexpensively guide, control, attach and accurately follow a cam-shaped path both under a positive downward force and during centrifugal acting outward forces within a compact unit while transferring linear motion into rotating power.

It is a further object of the present invention to provide a cam device for generating rotating power with the use of a bearing assembly which couple one or more piston rods with a cam crank in a manner which allows the coupling of the piston rod to precisely follow an intricate contour of the cam crank throughout an endless path of predetermined configuration.

It is still a further object of the present invention to provide a means for coupling piston rods to a cam crank for converting linear motion into rotating power and maintaining the piston rods coupled to the cam crank during times when outward separating forces occur, thereby maintaining constant coupling of the piston rods to the predetermined profile of the cam without the aid of any external means or devices, such as springs.

It is still a further object of the present invention to provide an improved internal combustion engine which provides for twice the firing power per revolution of the crank shaft, thereby providing for more efficient use of energy created during combustion and resulting in a significant increase in power output.

It is yet a further object of the present invention to provide an improved internal combustion engine which includes a cam crank device and means for effectively coupling piston rods to the cam crank device, and wherein the cam crank device provides for a longer, controlled and variable lever arm, thereby providing higher torque and variable torque curves.

It is a further object of the present invention to provide an improved combustion engine which creates inline movement of the pistons within the cylinders, thereby eliminating side loading and reducing friction between the piston rings and cylinder walls.

It is a further object of the present invention to provide an improved combustion engine which requires less piston ring tension, resulting in less friction between the pistons and cylinder walls.

It is still a further object of the present invention to provide an improved combustion engine which requires less parts in motion, thereby reducing friction.

It is still a further object of the present invention to provide an improved combustion engine which produces less friction, resulting in a more economical use of fuel.

It is yet a further objection of the present invention to provide an improved combustion engine which incorporates a rotating crank and means of connecting multiple pistons and rods to a single crank which is inherently balanced, thereby requiring no special counterbalance measures.

It is yet a further object of the present invention to provide an improved combustion engine which provides a smooth, sequential firing order with less duration between power cycles, thereby generating little or no vibration without the addition of mechanical dampening devices.

It is still a further object of the present invention to provide an improved combustion engine which is readily adapted for use and design with ceramics, thereby providing more efficient use and containment of the heat energy of combustion, with the ability to run the engine at elevated temperatures to produce higher power levels without the use of increased amounts of fuel.

It is still a further object of the present invention to provide an improved combustion engine which is readily adapted for use and design with ceramics, thereby requiring little to no lubrication.

It is still a further object of the present invention to provide an improved combustion engine which incorporates a rotating valve assembly which is readily adapted for computer-control valve timing using common and well-developed servo motor technology, thereby providing for ultra quick and precise response timing.

It is still a further object of the present invention to provide an improved combustion engine having a valve assembly which is readily adapted for computer-control, thereby providing the ability to control precise timing of the engine's performance and optimizing fuel economy without sacrificing performance.

### ADVANTAGES OF THE INVENTION

1. Design

a) Multi-shape. The engine can be configured in any of a variety of shapes to suit the intended use (e.g., radial, in line, in pairs).

b) Compact.

c) Multi-mount (e.g., vertical shaft; horizontal shaft).

d) Lightweight.

e) Air or water cooled.

2. Power

a) Every 360°=one power (twice as often as a conventional 4 stroke).

b) The ability to tailor the power curve by the shape of the crank.

c) The average mechanical leverage (vector force) generated per degree of rotation for the full stroke during the power cycle of the roller crank mechanism over the standard crankshaft is over 2-1.

By producing twice the mechanical leverage twice as often (i.e. every 360° rather than every 720°), more power is generated per equal size or the same power can be generated in a much smaller package.

3. Fuel Economy

a) Lightweight—Less mass to move.

b) Friction—Axial guided rods allows for use of piston rings with less cylinder wall tension and use pistons that generate zero side loading.

Less ring tension results in less friction.

Less parts in motion results in less friction.

Less friction results in better use of fuel.

c) Rotating valve assembly—Rotary valves are easier to control using common and well-developed servo motor technology, known in the industry for ultra quick and precise response timing.

The advantage to computer-controlled valves is the ability to allow for precise timing of an engine's performance optimizing fuel economy without sacrificing performance.

d) The ease of use and design with ceramics—The most efficient total use of and containment of the heat energy of combustion and the ability to run at elevated temperatures to produce higher power levels without the use of more fuel can only be achieved with the use of ceramics.

Ceramics require little to no lubrication.

4. Balanced

a) By design—The engine's rotating crank and the means of connecting multiples of piston and rods to a single crank is inherently balanced. No special counterbalance is needed.

b) Smooth sequential firing order (example 1-2-3) along with less duration between power cycles helps in generating little or no vibration without the addition of mechanical dampening devices.

5. Efficient Conversion of Reciprocating Linear Motion into Rotating Power

a) Single point coupling of piston rods to cam crank in a manner as to precisely follow the intricate contour of a cam crank device whose function is both to transmit linear power of combustion into rotating force and, during the times when outward separating forces occur, to maintain constant contact to the surface and profile of the cam without the aid of any external means or devices such as a spring.

b) Ease of attachment of multiple piston/rod combinations to a single cam crank device.

6. Piston Control and Piston Rod Weight

a) An engineered housing rigidly contains the entire engine assembly parts and incorporates linear guides for the piston/piston rod assembly. The linear guides restrict movement of the pistons and piston rods to linear movement, thereby allowing for the use of piston rings with less cylinder wall tension and the use of pistons that generate zero side loads. The mass, shape and the design of the piston rod combination are significantly reduced (approximately 90%). These advantages allow for the ease of sustaining higher power strokes per minute which are achieved with the use of the cam crank device.

7. Multi-engine Configurations

a) Utilizing a single or stacked cam crank devices to create a radial, in-line or paired or cylinder arrangements, multiple engine configurations are possible.

b) Multi-mounting positions in either vertical shaft or horizontal shaft are also possible.

c) The compact size of the engine also allows for the ease of design to employ either air or water cooling.

### SUMMARY OF THE INVENTION

The present invention provides a compact internal combustion engine which includes an engine housing, an arrangement of cylinders with reciprocating pistons, a crankshaft extending through the housing, a cam crank fitted to the crankshaft and rotatable with the crankshaft, and a valve assembly. Each piston includes a piston head slidably received within a respective cylinder and an integral connecting rod extending from the bottom of the piston head. A bearing arrangement couples the connecting rod of each piston to the cam crank in a manner which causes the coupling of the piston rods to follow an endless path of predetermined configuration upon reciprocating movement of the pistons and rotation of the cam crank. Upon firing of the respective cylinders, the pistons move in straight, axial alignment within the cylinders in a linear stroke movement, thereby delivering a power stroke to the cam crank, causing the coupled connecting rods to travel about the predetermined path as the cam crank is rotated. In this manner, the linear motion of the pistons is effectively, practically, efficiently and economically transferred into rotating power in a compact unit. In the preferred embodiment, the continuous path followed by the coupling of the piston connecting rod is defined by one or more cam-shaped grooves formed in the cam crank which serve to direct the reciprocating pistons through four complete strokes, including one power stroke, with each rotation of the cam crank. Accordingly, each cylinder of the engine delivers one power stroke for each rotation of the crankshaft.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded perspective view of the internal combustion engine of the present invention, in accordance with a preferred embodiment thereof;

FIG. 2 is an isolated exploded perspective view of a portion of the crankshaft, the cam crank, a piston head and connecting rod, and a bearing assembly for coupling the piston rod to the cam crank;

FIG. 3 is an isolated perspective view showing a piston/piston rod coupled to the cam crank; and

FIG. 4 is a side elevation, in partial section, showing the piston/piston rod coupled to the cam crank.

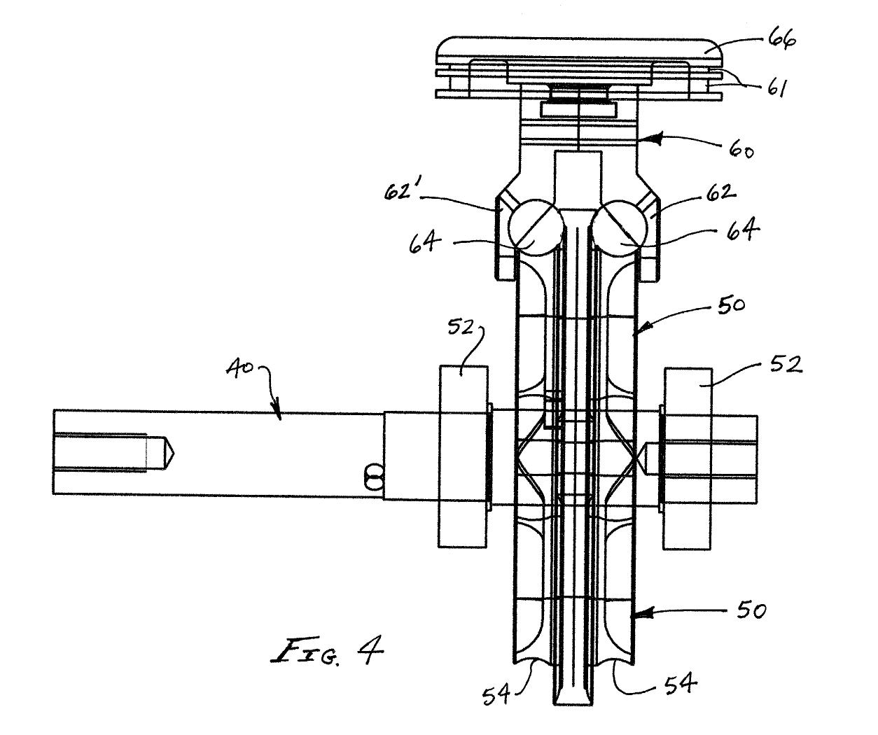

Like reference numerals refer to like parts throughout the several views of the drawings.

### DETAILED DESCRIPTION OF THE PREFERRED EMBODIMENT

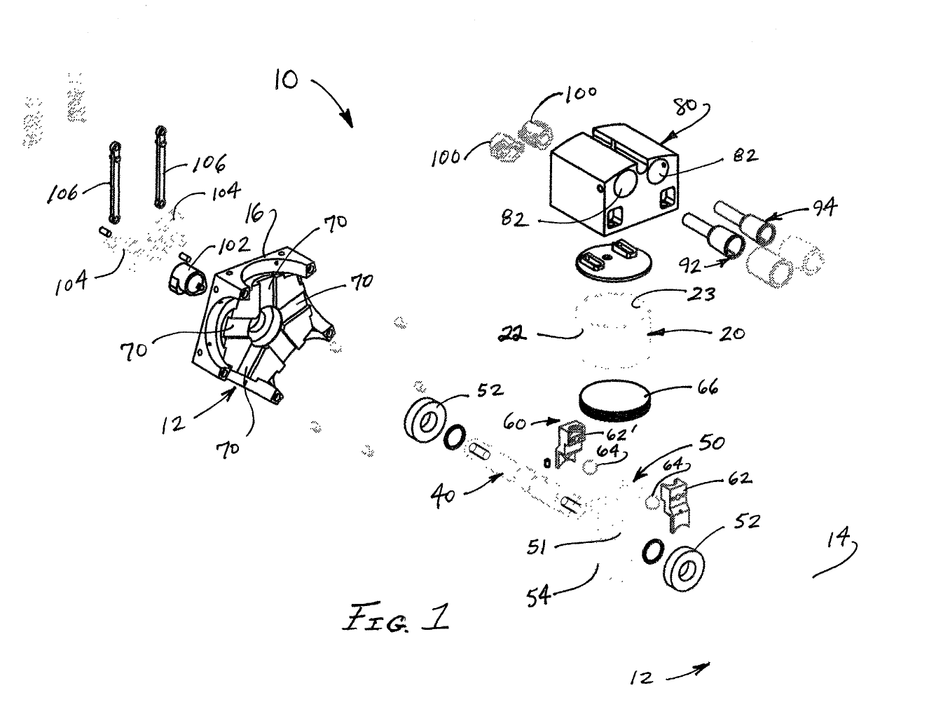

Referring to the several views of the drawings, the internal combustion engine of the present invention is shown and is generally indicated as 10. The engine 10 includes an engine housing 12 defined by opposing cover members 14, 16 which attach together to accommodate the engine components. In one embodiment, which is shown in FIG. 1, a plurality of cylinders 20 are spaced equally around the housing 12 and are radially disposed relative to a central axis 24. It is noted, however, that the cylinders may be arranged in a different configuration relative to the housing and central axis 24 such as, for example, a V arrangement or an in-line arrangement. The cylinders 20 are each fitted with a sleeve 22 which may be of various known materials for such use including steel, aluminum or ceramic. The inner surface 23 of the sleeve 22 defines an inner cylinder wall for engagement with rings on a piston head of pistons 60 to provide a seal between the piston head and cylinder wall as the piston head moves up and down in the cylinder.

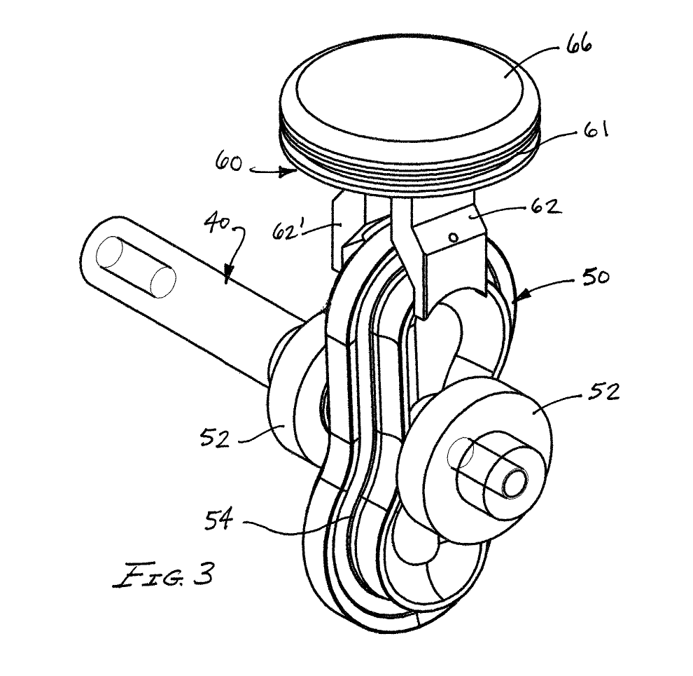

The main housing 12 is structured for passage of a crankshaft 40 therethrough. While only a portion of a crankshaft 40 is shown in FIGS. 1 and 3, it is noted that the crankshaft 40 extends through the engine interior along the central axis 24. A cam crank 50 is fitted to the crankshaft 40, in functional alignment with the cylinders 20, and is able to rotate with the crankshaft 40 about the central axis 24 within the housing. Bearings 52 are placed on the crankshaft 40 on opposite sides of the cam crank 50. It is noted that while the drawings show a single cam crank 50 for purposes of clarity and to facilitate an understanding of the operational components of the invention, more than one cam crank can be fitted, in series, along the crankshaft 40. In this instance, each cam crank 50 would be associated (i.e., aligned) with one or more cylinders 20 for driving reciprocating movement of pistons 60 therein, as described more fully hereinafter.

As described above, each cylinder 20 accommodates a reciprocating piston 60 having a pair of connecting rods 62, 62′ and bearings 64 for coupling the pistons 60 to the cam crank 50. The bearings 64 are captivated between the connecting rods 62, 62′ and peripheral grooves 54, defining a cam path on opposite sides 56, 58 of the cam crank 50. The bearing coupling assembly permits movement of the cam crank 50 relative to the connecting rods 62, 62′ and pistons 60. More specifically, as the cam crank 50 rotates, the ball bearings 64 travel along the grooves 54, about the predetermined cam path. By changing the distance between the grooves 54 and the central axis of rotation 24 of the cam crank about the cam path, the pistons 60 are able to move up and down in a linear reciprocating motion. In a preferred embodiment, the cam crank 50 and grooves 54 are specifically configured to cause reciprocating movement of the pistons 60 through four complete strokes for each rotation of the cam crank, thereby completing a full cycle (i.e., intake, compression, combustion and exhaust) with one power stroke for each 360° rotation of the crankshaft 40. Moreover, the configuration of the crank 50 and grooves 54 which accommodate the bearing coupling assembly can be varied in accordance with desired performance characteristics of the engine (e.g., torque curve). The coupling of the connecting rods to the cam crank, with the use of bearings 64, further serves to maintain the connecting rods 62, 62′ in straight, axial alignment with the respective cylinder 20 throughout the stroke, thereby preventing side loading of the piston head 66 against the cylinder wall 21.

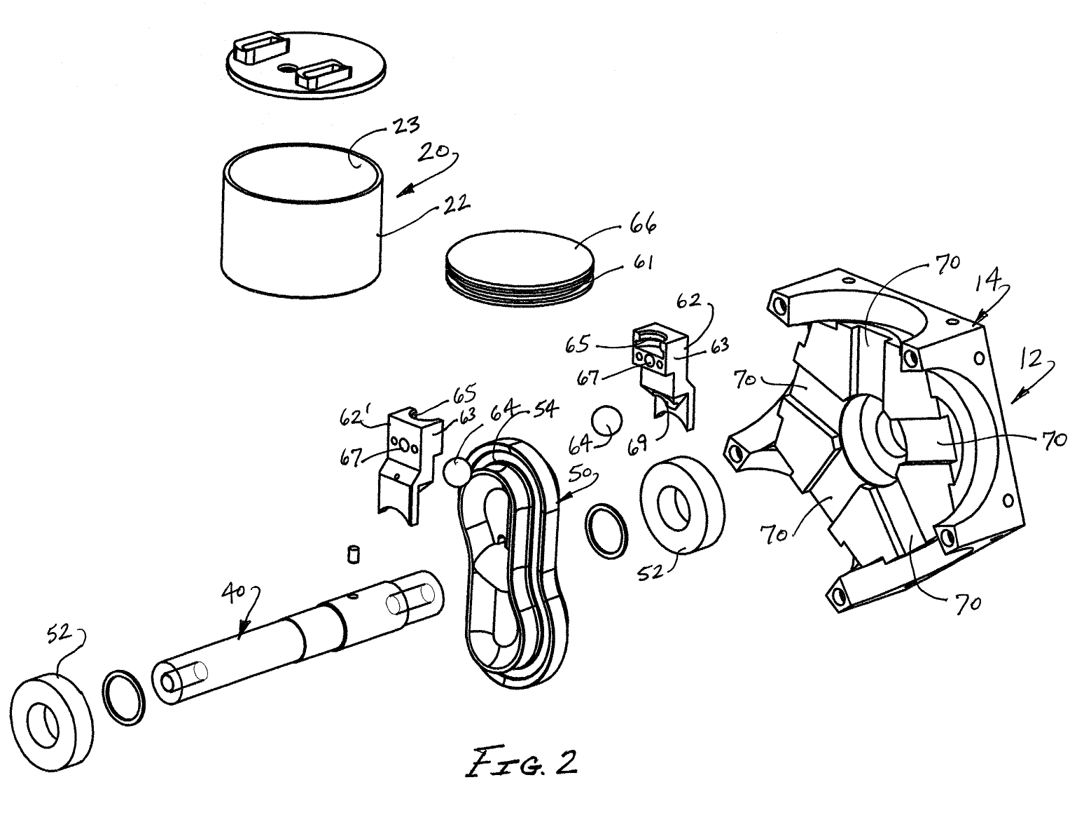

Referring to FIG. 2, a detailed exploded view of a piston 60 is shown, including the connecting rods 62, 62′, the piston head 66, and the bearings 64. The top portions of the connecting rods 62, 62′ are provided with slotted cavities 65 which are structured and disposed for captivated receipt of a congruently configured stem structure (not shown) extending from the bottom of the piston head 66. In assembly, the connecting rods 62, 62′ are brought together at the top portions 63 so that the slotted cavities 65 engage about and captivate the depending stem structure of the piston head 66, thereby securing the piston head 66 to the connecting rods 62, 62′. A bolt or other means (not shown) is fitted through aligned holes 67 formed through the connecting rods 62, 62′ to hold the connecting rods together, in assembly, with the piston head 66 attached thereto. As described above, the ball bearings 64 are each captivated between a respective one of the connecting rods 62, 62′ and a respective one of the continuous grooves 54 on each side of the cam crank 50. A socket 69 formed within the inner lower side of each connecting rod 62, 62′ accommodates a respective one of the ball bearings 64 therein so that the ball bearings 64 can freely rotate relative to the respective connecting rods 62, 62′ and the grooves 54 in the cam crank 50. In this manner, the bearings 64 are able to travel about the cam path, defined by the direction path of the grooves 54 as the cam crank 50 rotates and the pistons 60 move in a linear reciprocating action within the cylinders.

The piston heads 66 are provided with a plurality of annular grooves 61 to accommodate piston rings, in the same manner as on a piston head of a conventional combustion engine. However, it is noted that due to the straight, axial movement of the pistons 60 within the respective cylinders, which avoids excessive side loading, the piston rings can be of a reduced tension, thereby exerting less friction against the cylinder walls 23, and thereby providing more efficient use of fuel (i.e., better fuel economy).

The engine housing 12, formed by the two opposing housing end covers 14, 16 includes guides 70 which are specifically structured and configured for sliding movement of the connecting rods 62, 62′ therein. More particularly, the guides 70, in conjunction with the bearing 64 and groove 54 configuration, serve to hold the connecting rods 62, 62′ in the assembled condition so that they do not split apart or separate from the cam crank as a result of the force exerted downwardly on the piston 60 against the crank 50 or the centrifugal acting outward forces acting on the bearing coupling as the bearing 64 travels about the cam path. Specifically, the guides 70 surround the connecting rods 62, 62′ and prevent outward separation of the connecting rods while holding the bearings 64 captivated between the connecting rods and the respective raceways on the crank, as the piston 60 moves up and down through each stroke.

Each cylinder 20 is covered by a cylinder head 80 fitted to the outer side of the engine block 12. Chambers 82 on the cylinder head 80 accommodate intake and exhaust valve members 92, 94, respectively, of a rotating valve assembly 90. A stem 98 extends from the valve members 92, 94 and connects to a means for operating the valve assembly 90. In one embodiment, shown in the drawings, the valve operating means comprises an assembly of rocker arms 100, cams 102, lifters 104 and push rods 106. In this embodiment, the stem 98 of each valve member 92 connects to a respective rocker arm 100. Upon rotation of the crankshaft 40, a cam 102 urges spring biased lifters 104 against push rods 106 to turn the respective rocker arms 100. A slight turning of each rocker arm 100 results in outward axial movement of the respective valve member 92, 94 relative to the associated valve chamber 82 to open the respective valve member. In an alternative embodiment, the valve members 92, 94 are operated to the open and closed positions by computer control, using servo motors to move the valve members, thereby providing ultra-precise timing of the valve operation.

While the instant invention has been shown and described in accordance with several preferred embodiments which are believed to a best mode of the invention at the time of filing the original patent application, it is recognized that variations and departures from the instant disclosure may be made in the future and are contemplated within the spirit and scope of the invention.

What is claimed is:

1. An internal combustion engine comprising:
an engine housing;
at least one cylinder in said engine housing;
at least one reciprocating piston slidably maintained within said at least one cylinder and including a piston head and a connecting rod;
a crankshaft extending along a rotational axis through said engine housing;
a cam crank fitted to said crankshaft and rotatable therewith;
bearing means for moveably coupling said connecting rod of said at least one reciprocating piston to said cam crank; and
means on said cam crank for guiding said bearing means about a path of predetermined configuration and causing rotation of said cam crank as said at least one piston moves in a linear, reciprocating motion.

2. An assembly for converting linear motion to rotary motion in combination with an internal combustion engine comprising:
at least one reciprocating piston slidably provided within a cylinder of said internal combustion engine and including a piston head and a connecting rod, and said at least one reciprocating piston being structured and disposed to move in a linear reciprocating motion in response to forces applied to said piston head and said connecting rod, wherein producing a combustion force within said cylinder applies a force to said piston head, causing said at least one reciprocating piston to move in one direction of its reciprocating motion to provide a power stroke;
a cam crank fixed to a crankshaft and rotatable therewith;
bearing means for movably coupling said connecting rod of said at least one reciprocating piston to said cam crank; and
means on said cam crank for directing said bearing means about a continuous path of predetermined configuration causing rotation of said cam crank and said crankshaft upon reciprocating linear movement of said at least one reciprocating piston.

3. An assembly for converting linear motion to rotary motion comprising:
a rotatable shaft;
a cam crank fixed to said rotatable shaft and being rotatable therewith;
at least one reciprocating member moveable in a linear reciprocating motion;
bearing means for moveably coupling said at least one reciprocating member to said cam crank;
means on said cam crank for guiding said bearing means about a path of predetermined configuration and causing rotation of said cam crank as said at least one reciprocating member moves in said linear, reciprocating motion; and
means for maintaining said at least one reciprocating member coupled to said cam crank when subjected to both downward and upward linear forces and outward separating forces which occur throughout rotation of said cam crank as said bearing means follows said continuous path.
